(19) United States
(12) Patent Application Publication
(10) Pub. No.: US 2014/0316964 A1
(43) Pub. Date: Oct. 23, 2014

(54) Systems and Methods for Tracking Greenhouse Gas Emissions

(71) Applicant: Open Access Technology International, Inc., Minneapolis, MN (US)

(72) Inventors: Ilya William Slutsker, Plymouth, MN (US); Sasan Mokhtari, Eden Prairie, MN (US); Shahriar Sahba, SouthLake, TX (US); David Jerome Stangler, Plymouth, MN (US); Manuel Santos, Plymouth, MN (US)

(73) Assignee: Open Access Technology International, Inc., Minneapolis, MN (US)

(21) Appl. No.: 14/216,196

(22) Filed: Mar. 17, 2014

Related U.S. Application Data
(60) Provisional application No. 61/791,324, filed on Mar. 15, 2013.

(51) Int. Cl. G06Q 50/06

(52) U.S. Cl. CPC G06Q 50/06; G06Q 40/04
USPC 705/37

(57) ABSTRACT

A system and method such that users subject to greenhouse gas programs, such as the California Air and Resource Board Cap-and-Trade program, can identify what allowances and obligations said user has at any point in time. The invention will allow for data to be received from any source of carbon trades, emission forward prices, electronic tags (e-Tags), or other relevant emissions attributes. The invention will have all formulas and data necessary to determine a user's position. The invention will create reports necessary to show compliance with greenhouse gas programs.

### CROSS-REFERENCE TO RELATED APPLICATIONS

This application claims priority to U.S. Provisional patent application No. 61/791,324 filed Mar. 15, 2013, the entire content of which is hereby incorporated by reference.

Applicant has other co-pending applications directed to the energy market, namely:

SYSTEMS AND METHODS FOR DEMAND RESPONSE AND DISTRIBUTED ENERGY RESOURCE MANAGEMENT, filed Feb. 9, 2011 and assigned application Ser. No. 13/024158, the entire contents of which is hereby incorporated by reference.

AUTOMATION OF ENERGY TRADING, filed Dec. 30, 2011 and assigned application Ser. No. 13/140248, the entire contents of which is hereby incorporated by reference.

CERTIFICATE INSTALLATION AND DELIVERY PROCESS, FOUR FACTOR AUTHENTICATION, AND APPLICATIONS UTILIZING SAME, filed Oct. 15, 2013 and assigned application Ser. No. 14/054611, the entire contents of which is hereby incorporated by reference.

A renewable energy credit management system and method, filed Feb. 10, 2014 and assigned application Ser. No. 14/176590, the entire contents of which is hereby incorporated by reference.

Systems and methods of determining optimal scheduling and dispatch of power resources, filed on Mar. 17, 2014 (Docket No. O17.2P-15315-US03), the entire contents of which is hereby incorporated by reference.

Systems and methods for managing energy generation and procurement, filed on Mar. 17, 2014 (Docket No. O17.2P-15469-US03), the entire contents of which is hereby incorporated by reference.

Systems and methods for tracing electrical energy of a load to a specific generator on a power grid, filed on Mar. 17, 2014 (Docket No. O17.2P-15493-US03), the entire contents of which is hereby incorporated by reference.

Systems and methods for trading electrical power, filed on Mar. 17, 2014 (Docket No. O17.2P-15565-US03), the entire contents of which is hereby incorporated by reference.

Systems and methods for managing conditional curtailment options, filed on Mar. 17, 2014 (Docket No. O17.2P-15571-US03), the entire contents of which is hereby incorporated by reference.

Systems and methods for parameter estimation for use in determining value-at-risk, filed on Mar. 17, 2014 (Docket No. O17.2P-15955-US02), the entire contents of which is hereby incorporated by reference.

Systems and methods for managing transmission service reservations, filed on Mar. 17, 2014 (Docket No. O17.2P-15956-US02), the entire contents of which is hereby incorporated by reference.

Systems and methods for interfacing an electrical energy end user with a utility, filed on Mar. 17, 2014 (Docket No. O17.2P-15958-US02), the entire contents of which is hereby incorporated by reference.

Use of Demand Response (DR) and Distributed Energy Resources (DER) to mitigate the impact of Variable Energy Resources (VER) in Power System Operation, filed on Mar. 17, 2014 (Docket No. O17.2P-15959-US02), the entire contents of which is hereby incorporated by reference.

### FIELD OF THE INVENTION

The present invention relates generally to a system and methods providing a comprehensive solution for the trading, position analysis, and reporting of emissions transactions that can be used to minimize harmful emissions while allowing participants to avoid unnecessary penalties and identify underutilized assets.

### BACKGROUND OF THE INVENTION

Businesses in the energy industry are increasingly facing statutory requirements to track and meet certain regional emission requirements. These requirements are often derived from municipal programs, such as cap-and-trade programs. Cap-and-trade programs are market-based approaches used to control pollution by providing economic incentives for achieving reductions in the emissions of pollutants through municipalities attaching monetary penalties to the pollutants an energy provider is responsible for creating in the course of their business. This means that electricity marketers, generation companies, and retail providers must all submit reports on items such as the total power that they generate, export, import, or wheel through the boundaries of the controlling program.

One of the largest such cap-and-trade programs comes from the California Air Resource Board (CARB or California ARB). CARB regularly updates acceptable emission levels and requirements for various utilities, and requires energy participants to report on their compliance. This report has been mandatory since 2010. The specific CARB report describes the participant's generation, load, and flow components on a yearly basis and breaks the imports, exports, and wheel through by resource, region, and counterparty. Reports such as these aggregate hourly net import and export values into corresponding yearly totals to be used for the GHG penalty computation. With this information, carbon reduction programs determine the allowable amount of greenhouse gases the participant have generated and compare the value to the participant carbon allowances (Carbon Allowance). The calculations behind these allowed amounts change yearly, usually to become more stringent, making predictions by the entities bound by the program cumbersome. If the participant generated energy with a high amount of greenhouse gases (CMG) in contrast to its Carbon Allowances, then the participant may be charged a penalty or forced to buy such Carbon Allowances as would cover its excess GHG creation. If the participant created less greenhouse gases than its allowance, then the participant can trade its unused allowance. These fees will apply to hourly net imports. Participants may offset their imports with exports for the same hour.

The carbon reduction agencies behind these programs often face difficulties in defining the GHG penalty structure. This may result in a carbon reduction agency overcharging participants, which may lead to litigation. This is an issue market participants have already raised.

The penalties associated with carbon reduction program results in entities buying and selling carbon allowances to meet goals and take advantage of statutes. Carbon allowance futures and options are traded on stock exchanges such as the Inter Continental Exchange (ICE). As an example, California carbon allowance futures for vintage years 2013, 2014, 2015, and 2016 are currently traded on the ICE exchange.

At this point, most utilities manually add up their energy transactions and must either buy Carbon Allowances, or try to sell unused Carbon Allowances in marathon sessions at the conclusion of the reporting period. At such sessions utilities may not be able to identify buyers for their Carbon Allowances, and thus may be unable to capitalize on the expiring Carbon Allowances. This may also lead to utilities not garnering enough Carbon Allowances, resulting in heavy penalties from the carbon reduction agencies.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. §1.72.

### BRIEF SUMMARY OF THE INVENTION

The invention provides a comprehensive solution for the managing of carbon obligations and allowances. The invention will serve the needs of entities that purchase and sell energy in a carbon constrained market and therefore are subject to a cap and trade program. The invention will capture carbon trades, emissions forward prices, bilateral carbon trades, emissions attributes of applicable energy trades, as well as provide carbon allowance position management functionality and track surrender of carbon allowances for compliance.

### BRIEF DESCRIPTION OF THE SEVERAL VIEWS OF THE DRAWINGS

The present invention will be explained in more detail below by means of drawings.

FIG. 1 is a block diagram illustrating the flow of information of one embodiment of the invention.

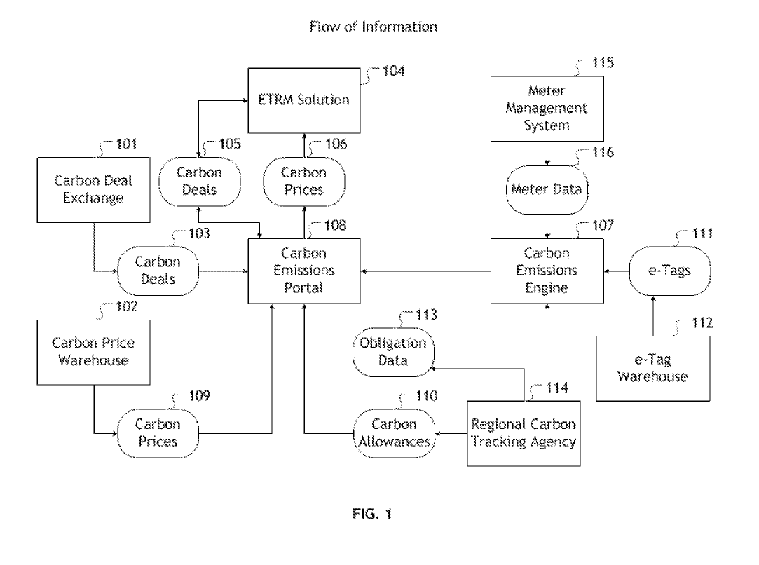

FIG. 2 is a block diagram illustrating a computer system.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

A typical user of the carbon emission module may be one who participates in the energy market such that they are subject to financial implications due to carbon emission based regulation. Trading in the energy market typically makes use of an Energy Trading and Risk Management (ETRM) software solution 104. The carbon emission module would integrate to this ETRM solution 104 as a carbon emissions module 108. In one embodiment the carbon emission module would integrate with the user's ETRM solution 104 via API. In the preferred embodiment, the ETRM solution 104 would be enabled to support incoming trades of carbon allowances. In one particular embodiment, the carbon emission module may integrate automatically with the OATI webTrader software-as-a-service solution via web service.

The carbon emission module is capable of handling numerous feeds of data. One form of data which the carbon emission module may receive is of Carbon Allowances trades 103, such trades hereinafter referred to as Deals 103. Such trades may be of futures, options, or bilateral carbon allowance. In the present embodiment only one trading exchange 101 is presented, but in some embodiments the carbon emission module may import Deals 103 from multiple such trading exchanges. This data feed from the exchange and the carbon emission module would be enabled with Financial Information Exchange protocol (FIX protocol). In one particular embodiment, the carbon emission module may be integrated directly into the Intercontinental Exchange and receive information through Fix protocol. Such import may be scheduled to trigger automatically after creation of a Deal 103 on the exchange 101, to regularly occur on a user-or-system-defined schedule, to occur upon a user/system defined trigger, or to occur upon user command. The carbon emission module may support the selection of an import trigger method to be a system option such that only a developer can set the import trigger method with a one-time customization or change the trigger via a software patch. The carbon emission module may also support the import trigger method being a user-configurable option, such that users may access the import trigger method in a menu of system options and therein change the import trigger method to their preferred method. In the preferred embodiment, only specially designated and authorized users may access and change such a menu of system options.

In one particular embodiment, Deals 103 imported from an exchange 101 may include both futures and options. The invention may convert the contents and format of Deals 103 consummated on the exchange 101 into a corresponding Deal 105 which the ETRM solution 104 can recognize. This conversion is performed on the carbon emission module through a process called mapping.

Mapping is the translation of all relevant information from the format of a Deal 103 imported from the Exchange 101 to the Deal 105 format necessary for successful export by the Carbon Emission Module 108 to the ETRM solution 104. The configuration behind this mapping may in a one-time effort. This may be in a single display, which in some embodiments can be referred to as a Mapping Page. In the preferred embodiment, the carbon emission module will come to the user with the formats from any Deal 103 from any exchanges 101 fully identified such that each field on a Deal 103 from an exchange 101 may be individually recognized and therein individually mapped. A user may engage this functionality by selecting the preferred ETRM solution 104 and the exchange 101 the user wishes to import Deals 103 from, Selection of the ETRM solution 104 and exchange 101 may be made by opening the mapping page and opening separate “drop down” menus for the exchange 101 and ETRM solution 104 in which likely ETRM solutions 104 and exchanges 101 may be available for selection and therein selecting the exchange 101 and ETRM solution 104 the user uses.

Deal formats may come preloaded in a system, such that selecting a given exchange 101 or ETRM solution 104 may have all fields from said exchange 101 or ETRM solution 104 immediately available. Selecting the exchange 101 and ETRM solution 104 may then display the Deal formats of those systems. Once the incoming exchange 101 format and the outgoing ETRM 104 solution format are displayed, the user could first select an incoming exchange 101 field as a feed and match it to an outgoing ETRM solution 104 field as a source, thereby linking the two fields together that incoming data is mapped to the preferred field by having the two formats open side-by-side in a GUI and having user click the two fields they wish to link and selecting a “map fields” button. In this way a user could specify how every imported Deal 103 from the exchange 101 which be displayed as an internal Deal 105 in the user's ETRM solution 104 format, therein automatically organizing the data as they prefer. In the event that fields change in an exchange 101 or ETRM solution 104, the carbon emission module may allow for the system fields to he updated with a software patch. The carbon emission module may then notify the user that incoming or outgoing Deals no longer match and prompt the user to download or request the newest patch to allow update of the mapping.

The carbon emission module may allow the user to specify which users may design such mapping, potentially only allowing designated users the ability to create or modify the mapping logic. Once designated, such users could open up the mapping display and complete the mapping configuration as required. Examples of fields the user may map include: the book in which the Deal 105 is stored (Book), the Deal 105 Type, the Deal 105 term, the Deal 105 time zone, the Deal 105 currency, the Deal 105 product, the Deal 105 contact, the Deal 105 financial type, the Deal 105 market, the zone within that market, index information, the broker, tax associated with the Deal 105, Deal 105 fees, Deal 105 counterparties, whether the Deal 105 is a payable or receivable Deal 105, and the due date of any given fees.

If a field which an ETRM solution 104 Deal 105 format requires is consistently blank or otherwise unavailable on the exchange 101 Deal 103, a qualified user may enter a default value to include in the Deal 105 created in the Carbon Emission Module 108 to make said Deal 105 conform to the user's ETRM solution 104 in the same mapping display by clicking on the required ETRM solution 104 Deal 105 field which is consistently blank and selecting a “default value” option to be the default value. The carbon emission module may also come with default Deal attributes 107 to facilitate this emission Deal integration. Any attribute not supplied by the emission Deal can then be “completed” with these default Deal attributes 107 by clicking on the same “default value” button as before and selecting an additional “system default values” option, from which the qualified user will be able to select the applicable imported default value.

These default values may be fully configurable by qualified users. Default attribute values for Deal 105 fields, whether inputted or manually entered, may be viewed and edited at a “default configuration” page, which lists all default attribute values. Listed default attribute values may be selected and edited on this page. The default attribute values can also be enabled or disabled by users for given situations on the same page by qualified users. In one particular embodiment, only certain users have the ability to so configure/enable/disable the default attribute values 107.

A mapped Deal 105 may be fully editable by qualified users. Any such edits may be performed from a Deal Summary Page, which displays all mapped Deals 105 in the system. At this page a qualified user may select a Deal 105 and choose an edit option, which will bring up the Deal 105 in a display where all fields are editable. After editing, the user can select to save the Deal 105 in the warehouse with the new values or cancel to leave the Deal 105 as it was before the user opened it. A qualified user will be able to edit any field of a Deal 105, such fields including book name, counterparty name, transaction type, trader name, executing trader, pricing type, financial physical flag, contract name, deal ID, firmness, term, deal time zone, export time zone, product, start date, end date, MW, price, currency, market, generator profile, trade date, creator, creation date, creation time, creation date time zone, profile time zone, total MW, total cost, contract number, and counter party full name, among others. Such fields of a Deal 105 may be editable by any means known in the art.

The carbon emission module may also allow Deals 105 to be inputted manually by qualified users. Such manual input may be performed from the Deal Summary Page by selecting a “new deal” option. The carbon emission module will display the Deal 105 format for the ETRM solution 104 the user has specified on their system options page. From here a qualified user could enter any acceptable value allowed by the field limits. When a Deal 105 is completed, the user can select a “create deal” option to put the Deal 105 into the database.

The carbon emission module may also allow for carbon allowance forward prices 109, hereinafter referred to as carbon prices, to be captured, displayed, and organized. To capture carbon prices 109, the carbon emission module may allow input from a carbon price source 102, which would usually be an exchange 101. In one particular embodiment, this may be accomplished through the use of an Application Programming Interface (API) linked to a carbon price source 102. In one embodiment, a user would enable a feed of carbon prices by identifying the preferred source 102 of carbon prices 109 and configuring this API within the code. Users can choose what exchange 102 to connect to this API; the user is not required to get prices from the same Exchange 101 as the user received Deals 103 from. Instead, users are able to input carbon prices 109 of Carbon Allowances 110 from any source 102 they desire based on a given year for carbon credit usage, said year hereinafter being referred to as a Vintage Year. All carbon prices 109 will be available to the user in a summary display which tracks the history of carbon prices 109. In one embodiment, carbon prices 109 would be configurable by qualified users within this summary display by selecting a given carbon price 109 and selecting an edit option, which would allow said qualified user to change the carbon price 109 to the preferred value.

The carbon emission module may also receive a feed of all electronic tags (e-tags) 111 that the user has contractual access to. This can be enabled by a feed from a central warehouse 112 to the invention. In one particular embodiment the carbon emission module integrates seamlessly with an electronic tagging system via web service. In one embodiment, a user would enable a feed of e-tags 111 by identifying a preferred source 112 of e-tags 109 and then configuring this feed within the code. From this feed the carbon emission module can pull all necessary e-tags 111. From the e-tags 111 the carbon emission module gathers information such as where the energy originated, what category of plant created the power, the posted efficiency factors of that category of plant, other specified source data, and all definitions for asset controlling suppliers to define the purchasing/selling entity for the energy who will have the final obligation to account for the carbon behind the energy.

The carbon emission module may also have a record of how much GHG for which a user is allowed to account. Carbon Allowances 110 may be allotted by a regional body that tracks compliance with the carbon emissions standards (said body herein after referred to as the Regional Body 114). Carbon Allowances 110 are typically calculated by the Regional Body 114 using a formula derived from the total energy the user is accounting for and the carbon goals of the area. A value is then provided by the Regional Body 114. This value can be either entered into the system manually at a Carbon Allowance 110 summary display by selecting an “enter Carbon Allowance” option or by enabling a feed from the Regional Body 114 through API to automatically input values.

The carbon emission module may then determine how much carbon a user is obligated to include in the user's final end-of-year settling (Obligations). Obligations are obtained with a formula 113 created, used, and disseminated by the Regional Body 114 which accounts for where the energy originated, what category of plant created the power, the posted efficiency factors of that category of plant, other specified source data, and all definitions for asset controlling suppliers to define the purchasing/selling entity for the energy who will have the final obligation to account for the carbon behind the energy, and where the energy went to. Obligations take into account how much GHQ emissions were produced by the creation of the energy accountable to a user. For example, if the user dealt with energy from wind and hydro power plants, said user would have accounted for very little GHG production, and therefore would have fewer Obligations. If the regional body 114 allows Obligation data 113 to come from its own databases, the carbon emission module can connect to the regional body 114 to obtain the Obligation data 113 through any means known in the art and as directed by the regional body 114. The carbon emission module may determine the Obligation by using the formula provided by the Regional Body 114 and filling formula values with data from applicable e-tags 111. If the carbon emission module determines the Obligation, the first step in this process is matching up unit numbers on the e-tag 111 with efficiency and classification material from publically available databases. The carbon emission module may receive information on how much liability 113 the user may incur as a result of an Obligation greater than the user's Carbon Allowance 110. This information may come from set liability rates that are determined by the Regional Body 114 and can be configured to update automatically in the system. All information and formulas necessary to determine Obligation data will be kept up to date even as it changes on a regular basis via the processes described and all possible factors for this calculation will be pulled from the e-tags 111 on that real-time Obligation data will always be available to the user. All of this data is stored in data warehouses available to the system and user.

With these Carbon Allowances 110 and Obligations 113, the carbon emission module has sufficient information to display the carbon position. In one embodiment the data received from the carbon emission module may be used to show hourly actual Obligation data on a carbon position summary display in a graphical format. This data may show how close or far the user is from their anticipated carbon position. The carbon emission module has extensive Carbon Allowance 110 manipulation ability. The carbon position summary display may be configured to show carbon positions for different time periods, whether days, months, or vintage years. In addition to being able to track Carbon Allowance 110 purchases and sales, the carbon emission module is also able to track Carbon Allowance 110 surrenders (hereinafter referred to as Retirements) and Carbon Allowance 110 inventory balances by leveraging the data warehouse.

At this point the user is ready to begin analyzing their carbon position. In one embodiment graphical displays on the carbon emission module will display a user's Obligations, Carbon Allowances 110, and the offset between these two for user-defined sets of time. The system allows the user to define these sets of time to such options as years, months, or other periods. In this way a user can see at any point in the year how many of their Carbon Allowances 110 they have accounted for, and whether their trajectory is projecting them to leave their Carbon Allowances 110 unused or to have Obligations in excess of their Carbon Allowances 110. The carbon emission module can also show how much money is at risk, whether by penalties associated with unsatisfied Obligations or by Carbon Allowances 110 which were not transitioned to Retirements. Risk from unsatisfied obligations can be determined from the total of the penalties and/or additional Carbon Allowances 110 which must be bought. Risk from Carbon Allowances 110 which were not transitioned to retirement can be determined from the total value of the unsold Carbon Allowances 110. The user can then use this information to make business decisions to use energy with less GHG impact or to start looking to sell unused Carbon Allowances 110, as the situation may dictate.

In addition, fields in the carbon position summary display can be expanded to show additional details. These details may include the user's retired Obligations, their open Obligations, the percentage of Obligations which are retired, the user's current monetary liability for any outstanding obligations, the initial allocations of Carbon Allowances 110, Carbon Allowance 110 purchases, and Carbon Allowance 110 sales. The carbon emission module may also allow users to further expand within these expanded values, for additional display of details, such as whether the purchased Carbon Allowances have since been surrendered, sold, or remain open. At this point a user may individually identify Carbon Allowances 110 as surrendered in case of a Deal 105 outside of the Exchange 101 or ETRM solution 104 has developed. In one embodiment, only users with special permission can individually identify Carbon Allowances 110 as being transitioned to Retirements.

The system may allow for export of all summary pages, including the carbon position summary page, into various file formats, including comma separated value file format, for analysis. The system may also enable users to create and view pivot tables with the carbon position data. In one particular embodiment, once the user specifies a date range, the data populates into a database for display as a chart. The user can then manipulate what information is to be determined, based on what variables and in what arrangement. The system may facilitate user modification of how data is organized in the chart for display by clumping together similar data points into mini-tables within the whole display. In one particular embodiment, the chart configurations may be saved for viewing or reference.

There are also numerous reporting options. For example, the deals 105 sent to the ETRM solution 104 may treat volume and cost data 106 as a lump sum linked to the first day of the allowance trade date range. The data within the deal 105 sent to the ETRM solution 104 may be configured to include checkout and invoicing functions in the ETRM solution 104. This data can also be exported via standard export protocols and displayed as reports. Any report generated by the carbon emission module can be identified to be sent to any number of recipients, and moreover can be sent immediately or designated to send at future points in time.

The carbon emission module may also be pre-loaded with dates. One such date is any scheduled sale of Carbon Allowances 110 directly from the regional body 114. In one embodiment, the carbon emission module may be pre-loaded with both auction and reserve sale dates from the California Air and Resource Board. The carbon emission module may have the date on which the user must declare their final schedule sale proceeds. The carbon emission module may also have the date for when the Regional Body 114 will collect evidence from the user that the user has not used ill-gotten Carbon Allowances 110 or otherwise been resource shuffling. The carbon emission module may include the dates which serve as deadlines for when the user must submit all data regarding Carbon Allowance 110 allocation to the Regional Body 114. The carbon emission module may include any dates by which the user must submit any compliance instruments to the Regional Body 114 for inspection. All of these dates may be viewable and/or modifiable within the invention. The invention may contain functionality to notify the user when a pre-loaded date is near using any method known in the art; such reminders may include an email sent to the user with information on the date, a pop-up window with information on the date, a flashing icon on the carbon emission module which can be opened to display information on the date or any other method known. As the Regional Body 114 creates more dates, the carbon emission module can be configured to be updated with these dates.

In preferred embodiments, all information flow will be preconditioned on secure identification and encrypted transmittals. In some particular embodiments the carbon emission module may utilize encryption enabling software, such as but not necessarily limited to digital certificates, to secure access to the invention and encrypt communications sent to and from the invention. Using any number of methods known in the art, the carbon emission module may require and validate for the presence of specific encryption enabling software as a login credential. In preferred embodiments, such encryption enabling software is associated on a one-to-one basis with a particular user account. Login to the system of such embodiment would be denied unless the system validates, using any method known in the art, that a user's request to access the system includes the correctly corresponding login credentials comprising of username, password, and encryption enabling software, among others, associated with a particular predefined user account. Moreover, in other embodiments, encryption enabling software may be utilized to encrypt data communications within the carbon emission module or between the carbon emission module and other systems

Moreover, communications between the carbon emission module and other systems may also be encrypted with encryption enabling software. Such encryption can be accomplished using any known means available in the art. As a non-limiting example, both the system of the present disclosure and a destination system can be set up with encryption enabling software, such as but not necessarily limited to digital certificates, to facilitate the encryption of communication sent from one system and the subsequent decryption of the information by the recipient system. Such pre-incorporation of encryption enabling software by both the sending system and recipient systems ensures that any intercepted communications cannot be read, thus raising the confidence level of commands, messages, and transmittals occurring within the system as a whole.

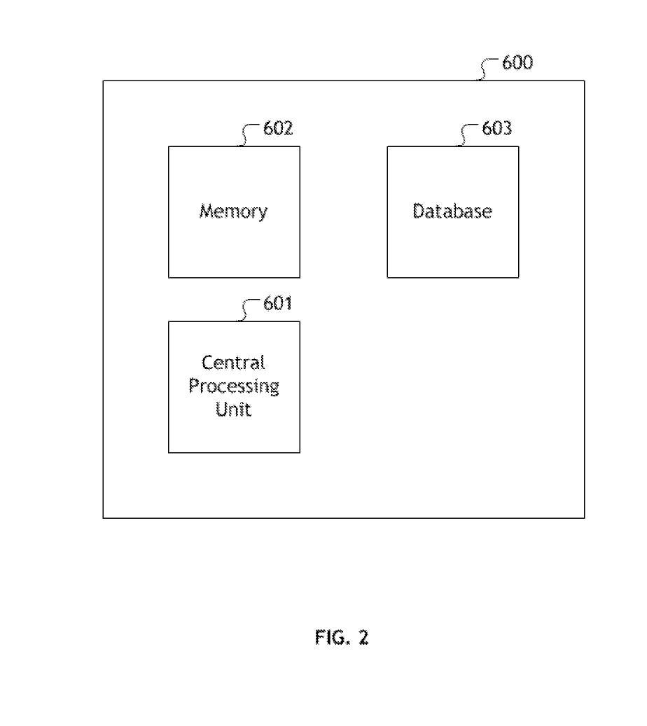

Some or all of the previously discussed embodiments may be performed utilizing a computer or computer system. An example of such a computer or computer system is illustrated in FIG. 2. Computer 600 contains Computer Processing Unit 601. Computer Processing Unit 601 may perform some or all of the processes involved in the previously discussed embodiments. Computer Processing Unit 601 may utilize information contained in Memory 602, Database 603, or both. Computer Processing Unit 601 may also write information to Memory 602, Database 603, or both. While in this FIG. 2 only one Computer 600 is shown, some embodiments may make use of multiple computers or computer systems. In some embodiments some of these computers or computer systems may not have dedicated memory or databases, and may utilize memory or databases that are external to the computer or computer system.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A method of tracking greenhouse gas emissions, comprising the steps of:
receiving input Deals to a database;
mapping input Deals to ETRM Deals;
receiving e-Tags to a database;
calculating Obligation position;
presenting Obligation position for analysis and manipulation, and;
track surrender of Carbon Allowances for compliance purposes.

2. The method of claim 1 wherein the input Deals are comprised of futures, options, and bilateral carbon trades.

3. The method of claim 1 wherein the Deal attributes of the Energy Trading and Risk Management (ETRM) solution are known and available for mapping.

4. The method of claim 3 further comprising the step of mapping input Deals to ETRM Deals

5. The method of claim 4 further comprising the step of integrating the invention with the ETRM software.

6. The method of claim 4 further comprising the step of establishing default values for any field desired in ETRM Deals.

7. The method of claim 6 further comprising the step of allowing the input Deal to be translated to ETRM format immediately upon upload.

8. The method of claim 5 further comprising the step of manually entering an ETRM Deal.

9. The method of claim 5 further comprising the step of editing any ETRM Deal in the invention.

10. The method of claim 9 further comprising the step of limiting ETRM Deal editing to certain designated users.

11. The method of claim 1 further comprising the step of receiving carbon prices from a carbon price source.

12. The method of claim 11 further comprising the step of editing carbon prices.

13. The method of claim 12 further comprising the step of limiting carbon price editing to certain designated users.

14. The method of claim 1 further comprising the step of pulling energy-generation and energy-path characteristics from the e-Tag warehouse to determine Obligations.

15. The method of claim 1 further comprising the step of importing meter data.

16. The method of claim 15 further comprising the step of pulling energy-generation and energy-path characteristics from the connected meter system to determine Obligations.

17. The method of claim 1 further comprising the use of a Carbon Emissions Engine and e-Tags, meter data, and Obligation data to determine Obligations.

18. The method of claim 17, further comprising the step of generating reports from Obligation and Carbon Allowance data.

19. The method of claim 14 further comprising the use of a Carbon Emissions Engine and e-Tags, meter data, and Obligation data to determine Obligations.

20. The method of claim 14 further comprising the use of a Carbon Emissions Engine and e-Tags, meter data, and Obligation data to determine Obligations.

21. A system for managing Deals, calculating Obligations, and tracking carbon position, comprising:
a computing device having a memory for running a program configured to:
determine Obligation and Carbon Allowance position and receive and map input Deals to ETRM Deals.

22. The system of claim 21 wherein the input Deals are obtained from exchanges.

23. The system of claim 21 wherein carbon prices are obtained from carbon price sources.

24. The system of claim 21 wherein Carbon Allowances and Obligation Data are obtained from a Regional Body.

25. The system of claim 24 wherein the program obtains and uses user's energy-generation and energy-path data from an e-Tag warehouse to determine user Obligations.

26. The system of claim 25 where the program is further enabled to allow the input and use of user's energy-generation and energy-path data from user's meters to determine user Obligations.

27. The system of claim 21 further including means for manual entry of Carbon Allowances and Obligation Data.

28. The system of claim 21 further including means to manipulate Obligation and Carbon Allowance positions to view trajectory over user-defined points in time.

29. The system of claim 28 further including means to simulate different future strategies to observe the impact upon projected Carbon Allowances and Obligations.

30. The system of claim 21 where the program further allows the input of ETRM Deals from ETRM solutions.

31. The system of claim 21 further including means for mapping an input Deal to an ETRM Deal.

32. The system of 31 wherein default values are used to specify any desired ETRM Deal field.

33. The system of claim 32 to further include means to edit any ETRM Deal.

34. The system of claim 21 further including means for using encryption methods for all system access and transmittals.
